(19) United States
(12) Patent Application Publication
(10) Pub. No.: US 2009/0002399 A1
(43) Pub. Date: Jan. 1, 2009

(54) Method and system for browsing pictures by using a keypad

(75) Inventors: Na Rao, Beijing (CN); Mingmin Gao, Beijing (CN); Xuelian Li, Beijing (CN); Yan Li, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: LENOVO (BEIJING) LIMITED, Beijing (CN)

(21) Appl. No.: 12/213,986

(22) Filed: Jun. 26, 2008

(30) Foreign Application Priority Data
Jun. 29, 2007 (CN) 200710118169.7

(51) Int. Cl. G09G 5/00

(52) U.S. Cl. 345/660

(57) ABSTRACT

The present invention relates to a method for browsing pictures by using a keypad, which comprises steps of: A. dividing a picture to be browsed into picture blocks corresponding to keys in a one-to-one correspondence according to a key disposition of an apparatus's keypad; B. determining a picture block corresponding to a currently pressed key by sensing the position of the pressed key; and C. selecting a mode for enlarging picture, and enlarging the picture with the center of the picture block determined in step B as its basis point. The method and system for browsing pictures by using a keypad improve the efficiency of enlarging pictures during the procedure of browsing pictures, can be simply implemented, and brings a novel interactive manner and a new experience to the users.

### BACKGROUND OF THE INVENTION

1. Field of Invention

The present invention relates to a method of picture browsing technique, and in particularly relates to a method and a system for browsing pictures by using a keypad.

2. Description of Prior Art

In recent years, photographic apparatuses such as handheld devices, in particularly photographic mobile phones become the popular goods purchased by users. With the popularization of the photographic mobile phones with a camera having a resolution of several million pixels and the occurrence of a camera having a resolution of dozens of millions pixels, more and more users use the photographic apparatuses to record the daily life. Therefore, the requirement of photographing and browsing pictures through the photographic apparatus by the users increases. Because of the improvement of the camera's resolution, the photo becomes larger and larger. However, because the photographic apparatus is restricted by the screen size, users often need to enlarge the pictures when browsing pictures through the photographic apparatus.

The current operating mode for browsing pictures through the photographic apparatus is to zoom in/out by using the zoom in/out key, with the center of the picture to be browsed as the base point. It needs several operation of pressing the key to adjust the picture to the desired target position so as to enlarge the picture in this manner, so it makes the operation complex and the efficiency low, and does not make user's experience good.

### SUMMARY OF THE INVENTION

The object of the present invention is to provide a method for browsing pictures by using a keypad, capable of simply, efficiently and rapidly browsing pictures on the handheld devices.

Another object of the present invention is to provide a system for browsing pictures by using a keypad, supporting to simply, efficiently and rapidly browse pictures in the handheld devices.

To achieve the objects as above described, the technical aspects of the present invention are proposed as follows.

According to a first aspect of the present invention, there is provided a method for browsing pictures by using a keypad, which comprises steps of:

A. dividing a picture to be browsed into picture blocks corresponding to keys in a one-to-one correspondence according to a key disposition of an apparatus's keypad;

B. determining a picture block corresponding to a currently pressed key by sensing the position of the pressed key; and

C. selecting a mode for enlarging picture, and enlarging the picture with the center of the picture block determined in step B as its basis point.

Preferably, said method further comprises a step of: D. determining whether the picture is enlarged to a preset enlarging threshold value, and when the picture has been enlarged to the enlarging threshold value, returning to an original picture browsing page by pressing any key of the keypad.

Preferably, said picture enlarging mode is a mode where the picture to be browsed is enlarged gradually with the center of the picture block corresponding to the currently pressed key as its base point, until it is enlarged to the preset enlarging threshold value; or a mode where the picture to be browsed is enlarged gradually with the center of the picture block corresponding to the currently pressed key as its base point, according to a time duration during which the key is being pressed, and the enlarging is stopped when the pressed key is released.

Preferably, said picture enlarging mode is selected according to a preset setting or according to the time duration during which the key is being pressed.

Preferably, said enlarging threshold value is 100%.

Preferably, said keypad is a numeric keypad, said keys comprise numeric keys, a “*” key and a “#” key.

Preferably, the picture to be browsed is divided into 12 picture blocks with a layout of 3×4 blocks.

Preferably, said apparatus is a handheld device.

According to a second aspect of the present invention, there is provided a system for browsing pictures by using a keypad, which comprises:

a region dividing module, for dividing a picture to be browsed into picture blocks corresponding to keys in a one-to-one correspondence according to a key disposition of a handheld device's keypad;

a sensing module, for deterring a picture block corresponding to a currently pressed key by sensing the position of the pressed key, and sending an enlarging instruction to a picture enlarging module; and

a picture enlarging module, for selecting a mode for enlarging picture, and based on the enlarging instruction from the sensing module, enlarging the picture with the center of the picture block corresponding to the currently pressed key.

Preferably, said system further comprises: a determining module, for determining whether the picture is enlarged to a preset enlarging threshold value, and when the picture has been enlarged to the enlarging threshold value, returning to an original picture browsing page by pressing any key of the keypad.

Preferably, said picture enlarging mode is a mode where the picture to be browsed is enlarged gradually with the center of the picture block corresponding to the currently pressed key as its base point, until it is enlarged to the preset enlarging threshold value; or a mode where the picture to be browsed is enlarged gradually with the center of the picture block corresponding to the currently pressed key as its base point, according to a time duration during which the key is being pressed, and the enlarging is stopped when the pressed key is released.

Preferably, said picture enlarging mode is selected according to a preset setting or according to the time duration during which the key is being pressed.

Preferably, said keypad is a numeric keypad, said keys comprise numeric keys, a “*” key and a “#” key.

Preferably, the picture to be browsed is divided into 12 picture blocks with a layout of 3×4 blocks.

The method and system for browsing pictures by using a keypad provided by the present invention divide the picture to be browsed into picture blocks corresponding to the keys in a one-to-one correspondence according to the key disposition of the apparatus's keypad, then determine the picture blocks corresponding to the currently pressed key by sensing the position of the pressed key, and thus may enlarge the picture with the center of the designated picture block as its base point.

Therefore, the method and system may not only improve the efficiency of enlarging pictures during the procedure of browsing pictures, can be simply, flexibly and conveniently implemented, but also may bring a novel interactive manner and a new experience to the users.

### BRIEF DESCRIPTION OF THE DRAWINGS

FIG. 1 is a schematic view of the principle flowchart for browsing pictures by using a keypad according to the present invention;

FIG. 2 is a schematic view of the operation flowchart for browsing pictures by using a keypad according to the present invention.

### DETAILED DESCRIPTION OF PREFERRED EMBODIMENTS

The key idea of the present invention is as follows: dividing a picture to be browsed into picture blocks corresponding to keys in a one-to-one correspondence according to a key disposition of an apparatus's keypad; determining a picture block corresponding to a currently pressed key by sensing the position of the pressed key; and enlarging the picture with the center of the determined picture block gradually until it is enlarged to a preset enlarging threshold value.

In the present invention, when the picture has been enlarged to the enlarging threshold value, it will return to an original full screen picture browsing page by pressing any key of the keypad.

Thereafter, the method for browsing pictures by using a keypad according to the present invention will be illustrated by using the handheld device as an example.

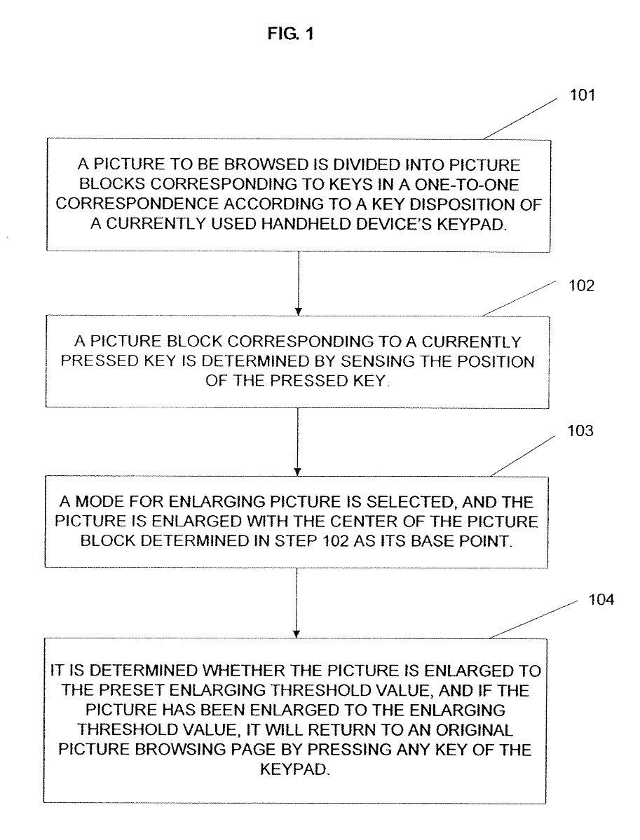

FIG. 1 is a schematic view of the principle flowchart of the method for browsing pictures by using a keypad according to the present invention. As shown in FIG. 1, the method for browsing pictures by using a keypad comprises steps as follows:

Step 101, a picture to be browsed is divided into picture blocks corresponding to keys in a one-to-one correspondence according to a key disposition of a currently used handheld device's keypad.

In the present invention, after entering the picture browsing page, there will be sub-area indication line present on the current displayed picture by pressing any key of the keypad.

Said keypad may be a numeric keypad.

Step 102, a picture block corresponding to a currently pressed key is determined by sensing the position of the pressed key.

Step 103, a mode for enlarging picture is selected, and the picture is enlarged with is the center of the picture block determined in Step 102 as its base point.

In the present invention, two picture enlarging modes are set: mode 1, the picture to be browsed is enlarged gradually with the center of the picture block corresponding to the currently pressed key as its base point, until it is enlarged to a preset enlarging threshold value; mode 2, the picture to be browsed is enlarged gradually with the center of the picture block corresponding to the currently pressed key as its base point, according to the time duration during which the key is being pressed, and the enlarging is stopped when the pressed key is released.

The selection of said picture enlarging modes can be realized by a preset setting, or it can be selected according to the time duration during which the key is being pressed. That is, if the time duration during which the key is being pressed does not reach a preset time duration, the picture enlarging mode 1 is selected; otherwise, the picture enlarging mode 2 is selected.

Step 104, it is determined whether the picture is enlarged to the preset enlarging threshold value, and if the picture has been enlarged to the enlarging threshold value, it will return to an original picture browsing page by pressing any key of the keypad.

If the picture has not been enlarged to the preset enlarging threshold value, any key of the keypad may be pressed again, and the sub-area indication line will be displayed on the browsed picture again. The keys may be selected again to further enlarge the picture with the center of the picture block corresponding to the currently selected key as its base point. Herein, “further enlarge” refers to that the picture block corresponding to the currently pressed key is selected to be further enlarged on the basis of currently enlarged picture.

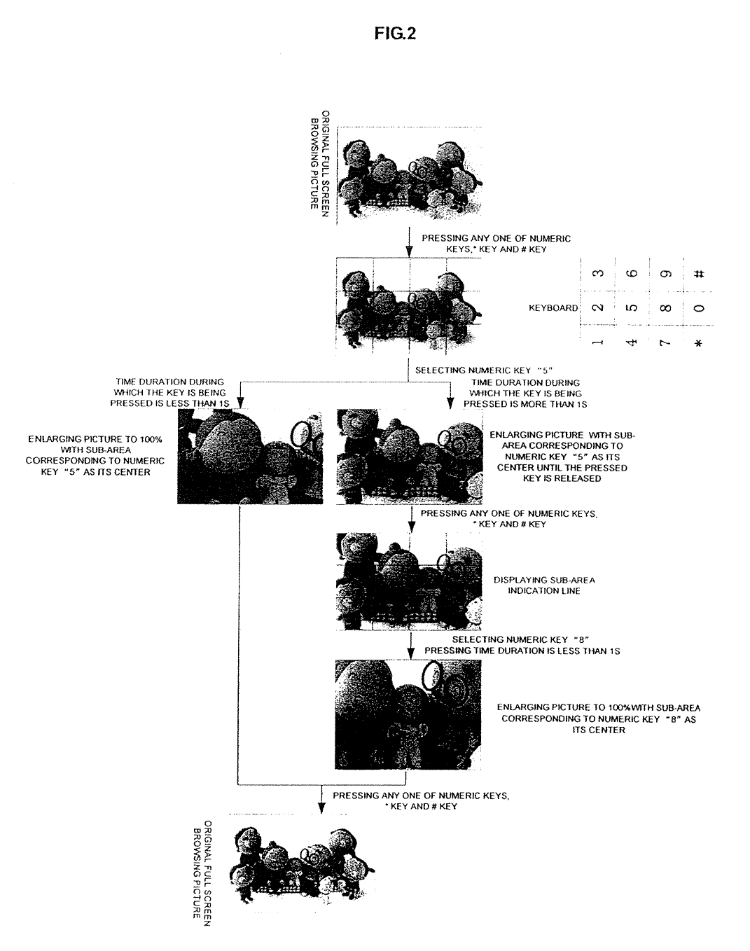

The method for browsing pictures by using a keypad according to the present invention will be further illustrated in conjunction with the detailed embodiment. FIG. 2 is a schematic view of the operation flowchart for browsing pictures by using a keypad according to the present invention.

In the embodiment, said handheld device is a mobile phone, said keypad is a 3×4 keypad composed of numeric keys, a “*” key and a “#” key. The enlarging threshold value is set to 100%.

The picture enlarging mode is selected according to the time duration during which the key is being pressed. In the present embodiment, the preset time duration is 1s. If the time duration during which the key is pressed does not reach 1s, the picture enlarging mode 1 is selected, otherwise the picture enlarging mode 2 is selected.

As shown in FIG. 2, the picture to be browsed which is currently displayed on the mobile phone is divided into 12 picture blocks with a layout of 3×4 blocks by using the characteristic that the numeric keys, the * key and the # key are usually in a layout of a continuous 3×4 blocks, each of the numeric keys, the * key and the # key is adapted to control the picture block of the corresponding position, respectively.

In the present embodiment, it is determined whether the picture is enlarged to 100%, which is based on the image resolution. When the resolution of the picture is enlarged to its original resolution, the enlarged ratio is determined as 100%.

In the current picture browsing page, if any one of the numeric keys, the * key and the # key, the sub-area indication line will be displayed on the picture. Assuming that numeric key “5” is selected, if the time duration during which the key is being pressed is less than is, the picture enlarging mode 1 is selected, and the picture is enlarged gradually with the center of picture block corresponding to the numeric key “5” as its base point, until the picture is enlarged to 100%; and if the time duration during which the key is being pressed is equal to or more than 1s, the picture enlarging mode 2 is selected, the picture is enlarged gradually with the center of the picture block corresponding to the numeric key “5” as its base point, and the enlarging is stopped when the pressed key is released. There will be sub-area indication line present on the picture again if any one of the numeric keys, the * key and the # key is pressed again. Assuming that the numeric key “8” is further selected and the picture enlarging mode 1 is further selected, the picture is further enlarged gradually with the center of the picture block corresponding to the numeric key “8” as its base point, until the picture is enlarged to 100%.

After the picture has been enlarged to 100%, it returns to the original full screen picture browsing page by pressing any one of the ten numeric keys, the * key and the # key.

The picture browsing method as described above may also be realized by a part of keys in the 3×4 layout keypad. For example, it can be realized by selecting 4 keys with 2×2 key layout. The picture to be browsed which is displayed on the mobile phone is then divided into 4 picture blocks with the layout of 2×2 blocks, and the 4 selected keys are adapted to control the picture blocks in their corresponding positions.

To realize the method for browsing pictures by using a keypad as described above, the present invention provides a system for browsing pictures by using a keypad, which comprises:

a region dividing module, for dividing a picture to be browsed into picture blocks corresponding to keys in a one-to-one correspondence according to a key disposition of a handheld device's keypad;

a sensing module, for deterring a picture block corresponding to a currently pressed key by sensing the position of the pressed key, and sending an enlarging instruction to a picture enlarging module;

a picture enlarging module, for based on the enlarging instruction from the sensing module, enlarging the picture with the center of the picture block corresponding to the currently pressed key;

a determining module, for determining whether the picture is enlarged to a preset enlarging threshold value, and when the picture has been enlarged to the enlarging threshold value, returning to an original picture browsing page by pressing any key of the keypad.

When a picture on a handheld device is needed to be browsed, firstly, the picture to be browsed is divided into picture blocks corresponding to the keys in a one-to-one correspondence by the region dividing module according to the key disposition of the current used handheld device's keypad; and then the sensing module detects whether a key is pressed in real time, and if it is pressed, the sensing module determines the position of the currently pressed key and thereby determines the picture block corresponding to the currently pressed key, and informs the determining module and the picture enlarging module; the picture enlarging module selects a picture enlarging mode, and according to the enlarging instruction from he sensing module, enlarges the picture with the center of the picture block corresponding to the currently pressed key as its base point, until the picture is enlarged to the preset enlarging threshold value; if the picture enlarging mode 1 is selected, the picture enlarging module enlarges the picture to be browsed gradually with the center of the picture block corresponding to the currently pressed key as its base point, until it is enlarged to the preset enlarging threshold value; and if the picture enlarging mode 2 is selected, the picture enlarging module enlarges the picture to be browsed gradually with the center of the picture block corresponding to the currently pressed key as its base point, according to the time duration during which the key is being pressed, and the enlarging is stopped when the pressed key is released.

Herein, said keypad is a numeric keypad, said keys comprise numeric keys, a “*” key and a “#” key. The picture to be browsed may be divided into 12 picture blocks with a layout of 3×4 blocks. The enlarging threshold value may be set as 100%.

What is described above is only the preferable embodiments of the present invention, and it is not intended to limit the scope of the present invention thereby.

What is claimed is:

1. A method for browsing pictures by using a keypad comprising steps of:
A. dividing a picture to be browsed into picture blocks corresponding to keys in a one-to-one correspondence according to a key disposition of an apparatus's keypad;
B. determining a picture block corresponding to a currently pressed key by sensing the position of the pressed key; and
C. selecting a mode for enlarging picture, and enlarging the picture with the center of the picture block determined in step B as its basis point.

2. The method for browsing pictures by using a keypad according to claim 1, further comprising a step of:
D. determining whether the picture is enlarged to a preset enlarging threshold value, and when the picture has been enlarged to the enlarging threshold value, returning to an original picture browsing page by pressing any key of the keypad.

3. The method for browsing pictures by using a keypad according to claim 2, wherein said picture enlarging mode is
a mode where the picture to be browsed is enlarged gradually with the center of the picture block corresponding to the currently pressed key as its base point, until it is enlarged to the preset enlarging threshold value; or
a mode where the picture to be browsed is enlarged gradually with the center of the picture block corresponding to the currently pressed key as its base point, according to a time duration during which the key is being pressed, and the enlarging is stopped when the pressed key is released.

4. The method for browsing pictures by using a keypad according to claim 3, wherein said picture enlarging mode is selected according to a preset setting or according to the time duration during which the key is being pressed.

5. The method for browsing pictures by using a keypad according to claim 4, wherein said enlarging threshold value is 100%.

6. The method for browsing pictures by using a keypad according to claim 4, wherein said keypad is a numeric keypad, said keys comprise numeric keys, a “*” key and a “#” key.

7. The method for browsing pictures by using a keypad according to claim 1, wherein the picture to be browsed is divided into 12 picture blocks with a layout of 3×4 blocks.

8. The method for browsing pictures by using a keypad according to claim 7, wherein said apparatus is a handheld device.

9. A system for browsing pictures by using a keypad comprising:
a region dividing module, for dividing a picture to be browsed into picture blocks corresponding to keys in a one-to-one correspondence according to a key disposition of a handheld device's keypad;
a sensing module, for deterring a picture block corresponding to a currently pressed key by sensing the position of the pressed key, and sending an enlarging instruction to a picture enlarging module; and
a picture enlarging module, for selecting a mode for enlarging picture, and based on the enlarging instruction from the sensing module, enlarging the picture with the center of the picture block corresponding to the currently pressed key.

10. The system for browsing pictures by using a keypad according to claim 9, further comprising:
a determining module, for determining whether the picture is enlarged to a preset enlarging threshold value, and when the picture has been enlarged to the enlarging threshold value, returning to an original picture browsing page by pressing any key of the keypad.

11. The system for browsing pictures by using a keypad according to claim 10, wherein said picture enlarging mode is
a mode where the picture to be browsed is enlarged gradually with the center of the picture block corresponding to the currently pressed key as its base point, until it is enlarged to the preset enlarging threshold value; or
a mode where the picture to be browsed is enlarged gradually with the center of the picture block corresponding to the currently pressed key as its base point, according to a time duration during which the key is being pressed, and the enlarging is stopped when the pressed key is released.

12. The system for browsing pictures by using a keypad according to claim 11, wherein said picture enlarging mode is selected according to a preset setting or according to the time duration during which the key is being pressed.

13. The system for browsing pictures by using a keypad according to claim 9, wherein said keypad is a numeric keypad, said keys comprise numeric keys, a “*” key and a “#” key.

14. The system for browsing pictures by using a keypad according to claim 9, wherein the picture to be browsed is divided into 12 picture blocks with a layout of 3×4 blocks.
